(19) United States
(12) Patent Application Publication
(10) Pub. No.: US 2014/0181540 A1
(43) Pub. Date: Jun. 26, 2014

(54) HYBRID BATTERY PACK

(71) Applicant: NVIDIA CORPORATION, (US)

(72) Inventors: Jevons Hua, Shenhen City (CN); Paul Su, Shenzhen City (CN); Simon Xu, Shenzhen City (CN)

(73) Assignee: NVIDIA CORPORATION, Santa Clara, CA (US)

(21) Appl. No.: 13/727,394

(22) Filed: Dec. 26, 2012

(51) Int. Cl. H01M 16/00; G06F 1/26

(52) U.S. Cl. CPC H01M 16/00; G06F 1/263
USPC 713/300; 429/7; 429/50

(57) ABSTRACT

A power source for supplying power to a mobile computing system comprising a Li polymer battery coupled in parallel with a supercapacitor cell battery. The Li polymer battery supplies substantially all the continuous currents demanded by the system load. The supercapacitor cell battery supplies substantially all the transient current demanded by the system load. The Li polymer battery may charge the supercapacitor cell battery when the voltage difference is larger than the difference caused by internal impedance difference.

### TECHNICAL FIELD

The present disclosure relates generally to the field of mobile computing systems, and more specifically to the field of power supplies for computing systems.

### BACKGROUND

With the development of application programs, display qualities and storage capabilities of mobile devices, as well as the exponential growth of Internet information, the functions of mobile computing devices, including laptops, PDAs, media players, touchpads, smartphones, etc., have been increasingly expanded and refined. Accordingly, users have demanded longer continuous runtime of mobile devices. Thus, the operating lifetime of a battery has become one of the critical features of such products as it determines the utility of the mobile devices in the normal situation where wall power is not easily accessible.

Mobile devices are commonly fitted with rechargeable Li-ion polymer batteries, or Li polymer batteries, which convert chemical energy to electrical energy through redox reactions. Li polymer batteries offer the advantages of high energy density, light weight, and high susceptibility to shaping, making them suitable for providing prolonged continuous usage time for mobile devices with slim designs.

However, Li polymer batteries usually have only moderate power density and cannot tolerate fast charge or discharge rate due to the nature of the chemical reactions in the cells. Typically, the maximum battery discharging rate is 1C and a larger discharging rate may irreversibly reduce the battery capacity. For example, a discharging rate of 2C may permanently damage the Li polymer battery. FIG. 1A is a data plot that illustrates the available capacity of a typical Lithium polymer battery used in a mobile device as a function of discharging rate. The curves 101-104 represent the battery Open Circuit Voltage (OCV) versus capacity at discharge rates of 0.2C, 0.5C, 1C and 2C respectively. It shows that the available capacity decreases with the increase of discharging rate. For example, at OCV of 3.5V, the available capacity at a discharge rate of 0.2C is 3150 mAh; whereas the available capacity at a discharge rate of 2C drops sharply to 600 mhA.

Furthermore, as a general rule, the amount of active chemicals transformed with each charge cycle is proportional to the depth of discharge. FIG. 1B is a data plot that illustrates the relation between the expected cycle life and the depth of discharge (DOD) for a typical rechargeable chemical battery, including a Li polymer battery. The number of cycles yielded by a battery, or the lifetime of the battery, goes down exponentially as the DOD goes deeper.

Transient currents are problematic to Li polymer batteries because they discharge the battery at high rates and likely cause deep discharge in a short time period. As a consequence, the operating lifetime of Li polymer batteries' tends to deteriorate. In addition, Li polymer cells generally have relatively large internal impedance which renders slow responses to transient currents.

On the other hand, the mobile computing devices require more and more power for higher performance and working frequencies. High transient currents that exceed the maximum battery discharging limitation may frequently occur during the operations of the devices, for instance, when a hardware component is activated from a low power state to a high power state in a very short time interval. Therefore, a user usually experiences battery capacity declining over time and battery lifetime being shorter than claimed by the manufacturer.

### SUMMARY OF THE INVENTION

Therefore, it would be advantageous to provide a battery system to a mobile computing device with both large energy density and large power density, so that the battery system can reliably supply transient currents to the device without its operating lifetime and capacity being eroded over time by the transient currents.

Accordingly, embodiments of the present invention provide a mechanism to protect a Li polymer battery from the degrading effects caused by transient currents while at the same time providing a battery that can supply transient current in a fast response time. Embodiments of the present disclosure advantageously employ a hybrid battery pack that includes a supercapacitor battery coupled in parallel with a Li polymer battery, with the supercapacitor battery operable to provide transient current and the Li polymer battery operable to provide continuous current to an electronic system.

In one embodiment of present disclosure, a power source for supplying power to a mobile computing system comprises a first battery and a second battery coupled in parallel with the first battery. The first battery is operable to supply substantially all demanded current to the system when it demands a current below a threshold rate. The second battery is configured to have significantly smaller internal impedance, and significantly larger power density than the first battery. The first battery can charge the second battery upon a voltage of the second battery dropping below a threshold voltage. The power source may further comprise a current limiter that can limit the current flowing between the first and the second battery. A control circuit may be employed to deactivate the first battery and activate the second battery when a transient current is detected.

In another embodiment of present disclosure, a mobile computing system comprises a power source and a system load coupled to the power source. The power source comprises a primary battery and a secondary battery coupled in parallel. The system load comprises a display panel, a bus, a main processor and a memory. The primary battery is operable to supply substantially all demanded current to the system when the demanded current is below a threshold rate. The secondary battery is configured to have significantly smaller internal impedance, and significantly larger power density than the primary battery. The primary battery can charge the second battery upon a voltage of the secondary battery dropping below a threshold voltage. Both the primary and the secondary battery are rechargeable through an external AC power supply. The power source may further comprise a current limiter that can limit the current flowing between the primary and the secondary battery. A control circuit may be employed to deactivate the first battery and activate the second battery when a transient current is detected.

In another embodiment of present disclosure, a method for supplying power to a mobile computing system comprises supplying substantially all current from a primary battery to the system if the system draws current below a threshold rate, and supplying substantially all current from a secondary battery to the system if the system draws current above the threshold rate. The primary battery is coupled with the secondary battery in parallel. Both the primary and the secondary battery are rechargeable through an external AC power supply.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A is a data plot illustrating the availably capacity as a function of discharging rate of a typical Lithium polymer battery used in a mobile computing device.

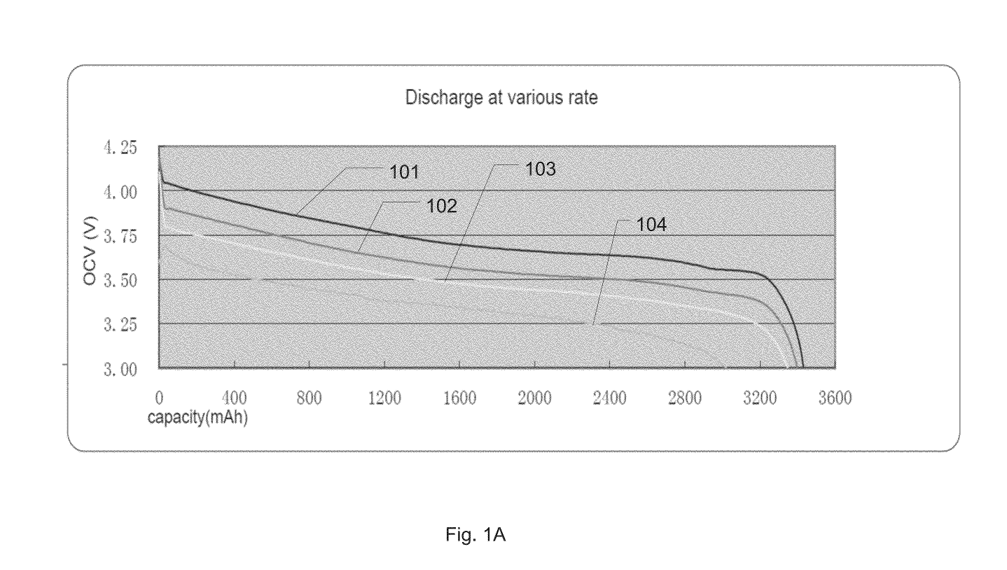

FIG. 1B is a data plot illustrating the relation between the expected cycle life and the depth of discharge for a typical rechargeable chemical battery.

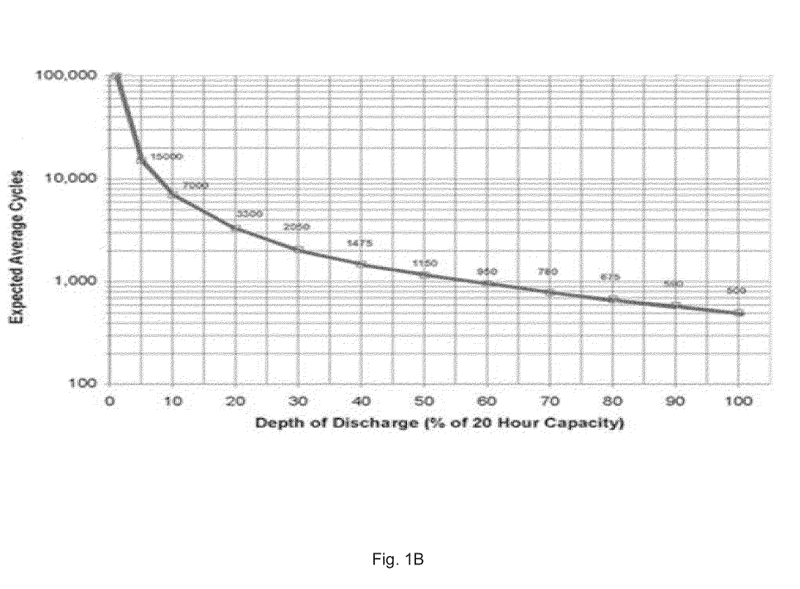

FIG. 2 is a block diagram illustrating a configuration of a hybrid battery pack coupled with a system load in accordance with an embodiment of the present disclosure.

FIG. 3 is a flow diagram of a method for providing power to a system load using a hybrid battery pack in accordance with an embodiment of the present disclosure.

FIG. 4 is a functional block diagram illustrating the configuration of a mobile computing system that comprises a hybrid battery pack coupled with other functional components in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Hybrid Battery Pack

Supercapacitor cells store energy through surface absorption of charges, as opposed to chemical reactions in the Li polymer batteries. Compared to Li polymer batteries, supercapacitor cell batteries are characterized having much higher power discharging capacities, or power densities, and smaller internal impedances. Thus, supercapacitor cell batteries are capable of supplying transient currents in a fast response time without negative effects on their operating lifetime or capacities. Although the feature of low energy density limits their application as the exclusive or primary battery in a mobile computing system, supercapacitor cells can be used as a secondary battery devoted to providing transient currents, in accordance with embodiments of the present disclosure.

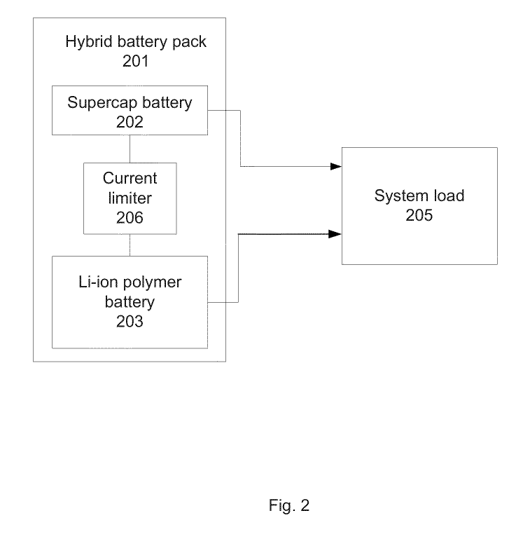

FIG. 2 is a block diagram illustrating a configuration of a hybrid battery pack 201 coupled with a system load 205 in accordance with an embodiment of the present disclosure. The hybrid battery pack 201 comprises a Li polymer battery 203 coupled in parallel with a supercapacitor cell 202. The Li polymer battery 203 has significantly higher energy density than the supercapacitor cell 202 and thus has the capacity to maintain constant voltage for long operating periods. In some embodiments, the Li polymer battery 203 is capable of storing 10˜100 times more energy than the supercapacitor cell 202. On the other hand, the supercapacitor cell 202 has significantly higher power density and can discharge at a significantly higher rate, e.g., 2C or above, than the Li polymer battery 203, which accounts for its capability of tolerating transient current without sacrificing lifetime. In addition, the supercapacitor cell 202 has significantly lower internal impedance than the Li polymer battery 203. Accordingly to one embodiment, the internal impedances of Li polymer battery 203 and the supercapacitor cell battery 202 are approximately 180 mΩ and 15 mΩ respectively, for instance.

During normal operation, the system load 205 demands continuous current from the battery pack 201, which yield a discharging rate well within the nominal limit, e.g. 0.5C, of the Li polymer battery 203. In this situation, the Li polymer battery 203 can supply substantially all the demanded current to the system load 205. Moreover, when the system load 205 attempts to draw a transient current, e.g. at a rate larger than 0.5C, the supercapacitor cell 202 advantageously takes over and supplies substantially all the demanded current. This transition to using the supercapacitor is attributed to smaller internal impendence of the supercapcitor cell 202 than that of the Li polymer battery 203, which also renders faster response time to the transient current. Because the supercapcitor cell 202 has high power density and can operate reliably at high discharging rates, the transition offers the benefit of supplying the demanded current in a fast response time and protecting the Li polymer battery 203 from degrading effect caused by the high discharging rate. Thereby, the effective lifetime of the Li polymer battery 203 is extended.

In some embodiments, although both batteries, 202 and 203, can be recharged to the same voltage level through an external charger, e.g., an AC adaptor, a voltage difference on the two batteries may develop after a short operating time once the external charger is disconnected, which results in current flowing, or charging, between the two batteries due to their parallel connection. Due to the low energy stored in the supercapacitor cell 202, the supercapacitor cell likely loses its voltage capacity faster. Thus there may be current flowing from the Li polymer battery 203 to the supercapacitor cell 202 attempting to equalize the voltages of the two. Under some circumstances, this current may itself be a transient current and poses a risk of damaging the Li polymer battery 203. To protect the Li polymer battery 203 from this risk, a current limiter 206 may be connected between the two batteries to limit the current flowing between the two batteries, in accordance with an embodiment of the present disclosure.

In some embodiments, a control circuit may be coupled to the two batteries and control the usage of the batteries based on the discharging rates of the demanded current. When a transient current is detected from the system load 205, the control circuit may deactivate the Li polymer battery 203 or isolate it from the system load 205 to protect it from the transient current. At the same time, the supercapacitor cell 202 is activated to supply all the demanded current to the system.

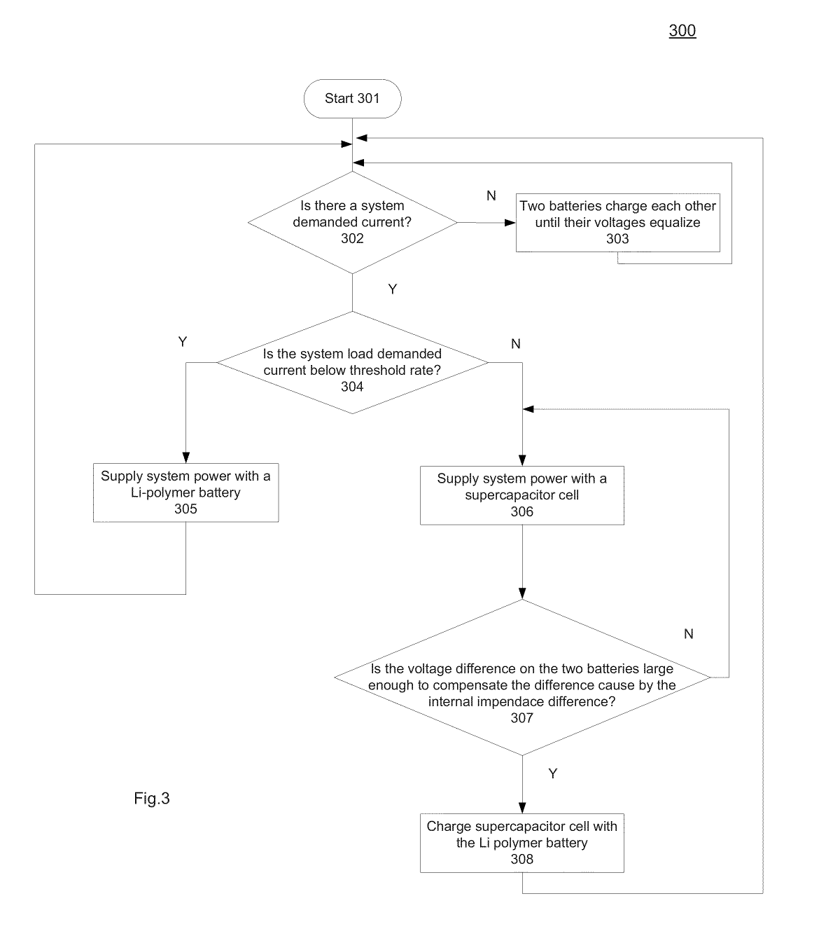

FIG. 3 is a flow diagram depicting a method 300 for providing power to a system load using a hybrid battery pack in accordance with an embodiment of the present disclosure. When the system load is determined to draw no current at 302, e.g. at an idle status, any voltage difference between the Li polymer battery and the supercapacitor cell can cause the two batteries to supply current to each other until their voltages equalize at 303 because of the parallel connection.

When the system load demands current as determined at 302, it is then to be determined whether the current is continuous or transient at 304. In the majority of the times, or the normal operation, the system load typically demands a continuous current that requires a discharging rate below a threshold rate from the battery pack. In this situation, the Li polymer battery supplies substantially all the current to the system load at 305. The threshold rate can be any discharging rate at which the Li polymer battery can operate without suffering degrading effect. According to one embodiment, the threshold rate is substantially 1C, for instance.

On the other hand, if the current is determined to be above the threshold rate at 304, the supercapacitor cell is used to supply substantially all current to the system load at 306. Meanwhile, if the voltage difference between the two batteries is large enough to compensate the voltage difference caused by the internal impedance difference at 307, the two batteries may charge each other at 308. As the supercapacitor cell has relatively small energy density, its voltage may drop faster than the Li polymer battery voltage. In this situation, the supercapacitor cell draws current from the Li polymer battery at 308.

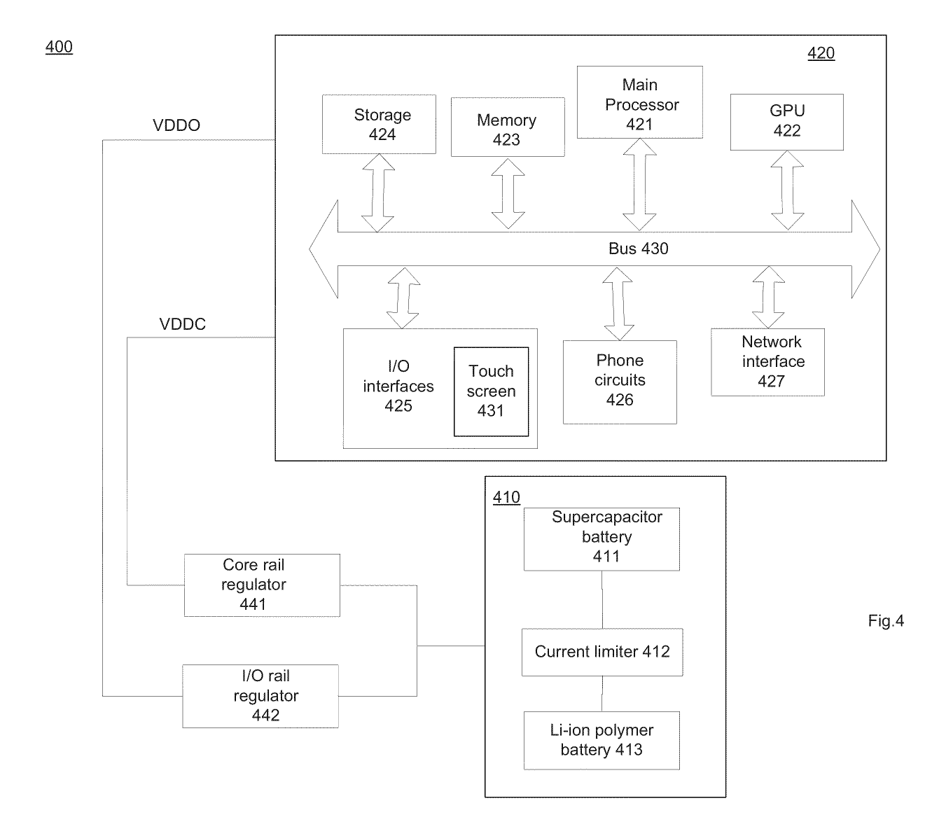

FIG. 4 is a functional block diagram illustrating the configuration of a mobile computing system equipped with a hybrid battery pack 410 that is coupled with a system load 420 in accordance with an embodiment of the present disclosure. In some embodiments, the mobile computing device 400 can provide computing, communication and /or media play back capability. The mobile computing device 400 can also include other components (not explicitly shown) to provide various enhanced capabilities. The system load 420 comprises a main processor 421 for processing electrical data, a memory 423, an optional Graphic Processing Unit (GPU) 422, network interface 427, a storage device 424, phone circuits 426, I/O interfaces 425 which may include a touch screen 431, and a bus 430.

The main processor 421 can be implemented as one or more integrated circuits and can control the operation of mobile computing device 400. In some embodiments, the main processor 421 can execute a variety of operating systems and software programs and can maintain multiple concurrently executing programs or processes. The storage device 424 can store user data and application programs to be executed by main processor 421, such as video game programs, personal information data, media play back program. The storage device 424 can be implemented using disk, flash memory, or any other non-volatile storage medium.

Network or communication interface 427 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 427 can provide wired network connectivity instead of or in addition to a wireless interface. Network interface 427 can be implemented using a combination of hardware, e.g. antennas, modulators/demodulators, encoders/decoders, and other analog/digital signal processing circuits, and software components.

I/O interfaces 425 provide communications and controls between the mobile computing device 400 with other external I/O devices, e.g. a computer, an external speaker dock or media playback station, a digital camera, a separate display device, a card reader, a disc drive, in-car entertainment system, a storage device, user input devices or the like.

The hybrid battery pack 410, as described above, including a supercapacitor battery 411, a Li polymer battery 413 and a current limiter 412, is coupled to and supplies demanded power to the system load 420 through voltage regulators 421 and 422.

The core rail regulator 421 regulates the power provided by the hybrid pack to a core domain voltage VDDC which is distributed to the core domain logic. The I/O rail regulator 422 regulates the power provided by the hybrid pack to an I/O domain voltage VDDO which is distributed to the I/O domain logic. In some embodiments, the system may comprise more than two power domains to which the hybrid battery pack 410 can supply power.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

1. A power source for supplying power to a mobile computing system, said power source comprising:
a first battery operable to supply substantially all demanded current to said mobile computing system when said demanded current is below a threshold rate; and
a second battery coupled in parallel with said first battery;
wherein said second battery is configured to have significantly smaller internal impedance than said first battery;
wherein said second battery is configured to have significantly larger power density than said first battery;
wherein said second battery is configured to have significantly smaller energy density than said first battery; and
wherein further said first battery is operable to charge said second battery upon a voltage of said second battery being below a threshold voltage.

2. The power source as described in claim 1, wherein said secondary battery is operable to supply substantially all demanded current to said mobile computing system when said demanded current is higher than a threshold rate.

3. The power source as described in claim 1, wherein both said first battery and said second battery are rechargeable through an external AC power supply.

4. The power source as described in claim 1, wherein said threshold rate is substantially equal to 1C.

5. The power source as described in claim 3, wherein said first battery comprises a Lithium polymer battery, and wherein said second battery comprises a supercapacitor cell.

6. The power source as described in claim 1 further comprising a current limiter operable to control current flowing between said first and said second battery.

7. The power source as described in claim 1 further comprising a control logic coupled to said first and said second battery, wherein said control logic is operable to, responsive to said mobile computing system demanding current at a rate that is higher than said threshold rate:
deactivate said first battery;
activate said second battery; and
cause said second battery to supply substantially all current demanded by said mobile computing system.

8. The power source as described in claim 1, wherein said first battery is operable to store an amount of energy at least ten times greater than said second battery.

9. The power source as described in claim 1, wherein said second battery is operable to reliably supply power to said mobile computing system at a rate of substantially 2C.

10. A mobile computing system comprising:
a power source comprising a primary battery and a secondary battery coupled in parallel with said primary battery;
a system load coupled to said power source and comprising: a display panel;
a bus; a main processor and a memory;
wherein said primary battery is operable to supply substantially all demanded current to said system load while said demanded current is below a threshold rate;
wherein said secondary battery is configured to have significantly smaller internal impedance than said primary battery;
wherein said secondary battery is configured to have significantly larger power density than said primary battery;
wherein said secondary battery is configured to have significantly smaller energy density than said primary battery;
wherein said primary battery is operable to charge said secondary battery when a voltage of said secondary battery is below a threshold voltage; and
wherein further both said primary and said secondary battery are rechargeable through an external AC power supply.

11. The mobile computing system as described in claim 10, wherein said secondary battery is operable to supply substantially all demanded current to said system load while said demanded current is higher than said threshold rate.

12. The mobile computing system as described in claim 11, wherein said threshold rate is substantially equal to 0.5C.

13. The mobile computing system as described in claim 9, wherein said primary battery comprises a Lithium-ion polymer battery; and wherein said secondary battery comprises a supercapacitor cell.

14. The mobile computing system as described in claim 9 further comprising a current limiter, coupled in between said primary battery and said secondary battery, said current limiter operable to control current flowing between said primary and said secondary battery.

15. The mobile computing system as described in claim 9 further comprising logic operable to, upon said system load demanding current in a rate that is higher than said threshold rate:
deactivate said primary battery;
activate said secondary battery; and
cause said secondary battery to supply substantially all current demanded by said system load.

16. The mobile computing system as described in claim 9 wherein said primary battery is operable to store an amount of energy at least ten times greater than said secondary battery during each charging cycle.

17. The mobile computing system as described in claim 9, wherein said secondary battery is operable to reliably supply power to said computing system at a rate of substantially 2C.

18. The method for supplying power to a mobile computing system, said method comprising:
supplying substantially all current from a primary battery to said computing system if said computing device draws current below a threshold rate; and
supplying substantially all current from a secondary battery to said computing system if said computing device draws current above said threshold rate;
wherein said primary battery is coupled with said secondary battery in parallel; and
wherein both said primary and said secondary battery are rechargeable through an external AC power supply.

19. The method as described in claim 18 further comprising controlling current flowing between said primary battery and said secondary battery.

20. The method as described in claim 19 further comprising ceasing supplying current from said primary battery upon said mobile computing device drawing current at a rate greater than said threshold rate.
